(19) United States
(12) Patent Application Publication
(10) Pub. No.: US 2017/0161731 A1
(43) Pub. Date: Jun. 8, 2017

(54) Resource processing method and device

(71) Applicants: LE HOLDINGS (BEIJING) CO., LTD., ChaoYang District (CN); LEMOBILE INFORMATION TECHNOLOGY (BEIJING) CO., LTD., Chaoyang District (CN)

(72) Inventor: Lei DENG, Chaoyang District (CN)

(21) Appl. No.: 15/241,623

(22) Filed: Aug. 19, 2016

Related U.S. Application Data
(63) Continuation of application No. PCT/CN2016/088460, filed on Jul. 4, 2016.

(30) Foreign Application Priority Data
Dec. 7, 2015 (CN) 2015108889174

(51) Int. Cl. G06Q 20/38; G06K 19/073; B60R 11/04; G06K 9/00

(52) U.S. Cl. CPC G06Q 20/385; G06K 9/00791; G06K 19/073; B60R 11/04

(57) ABSTRACT

The present disclosure discloses a resource processing method and device. In the example of the present disclosure, a designated image collected by a vehicle-mounted terminal device is acquired, and accordingly a user service resource is obtained according to the designated image, so that the user service resource can be used for performing a related service such as a payment service.

### CROSS REFERENCE TO RELATED APPLICATIONS

This application is a continuation of International Application No. PCT/CN2016/088460, filed on Jul. 4, 2016, which is based upon and claims priority to Chinese patent application No. 201510888917.4 entitled “RESOURCE PROCESSING METHOD AND DEVICE”, filed with State Intellectual Property Office of People's Republic of China on Dec. 7, 2015, which is incorporated by reference herein in its entirety.

### TECHNICAL FIELD

The present disclosure relates to communication technologies, and more specifically, to a resource processing method and device.

### BACKGROUND

With the development of Internet technologies, there emerges more and more applications based on the Internet, which are becoming more and more complex. The applications all relate to resource processing, and more specifically, to resource exchange processing, that is, exchanging one resource into another one. For example, real currency in a bank account or virtual currency in a corporation account is exchanged into other resources, such as various commodities or gasoline, provided by various services.

In the study of realizing the disclosure, the inventor has found a problem: during a resource exchange process, a physical card or an electronic card corresponding to a bank account or a corporation account needs to be provided by a user; in this way, the operation is complex and takes a long time, and is prone to errors, thus resulting in decreased efficiency and reliability of resource exchange.

### SUMMARY

Multiple aspects of the present disclosure provide a resource processing method and device, so as to improve efficiency and reliability of resource exchange.

According to a first aspect of the present disclosure, provided is a resource processing method, including:

acquiring a designated image collected by a vehicle-mounted terminal device;

obtaining a user service resource according to the designated image; and

performing a relevant service with the user service resource.

According to the foregoing aspect and any possible embodiment, an embodiment is further provided, that is, before the step of obtaining a user service resource according to the designated image, the method further includes:

establishing the mapping relationship between the designated image and the user service resource so as to obtain the user service resource corresponding to the designated image according to the designated image.

According to the foregoing aspect and any possible embodiment, an embodiment is further provided, that is, the user service resource includes a user payment service resource.

According to the foregoing aspect and any possible embodiment, an embodiment is further provided, that is, the step of obtaining a user service resource according to the designated image includes:

performing image recognition processing on the designated image so as to obtain a recognition result;

acquiring the user service resource according to the recognition result;

According to the foregoing aspect and any possible embodiment, an embodiment is further provided, that is, the designated image includes at least one or more of the following images:

a barcode image;

an object image; and

a picture image.

According to a second aspect of the present disclosure, provided is a resource processing device, including:

One or more of processor, and a storage.

Wherein, one or more program is stored in the storage. One or more program is executed by one or more processor, and enables one or more processor to perform:

acquiring a designated image collected by a vehicle-mounted terminal device;

obtaining a user service resource according to the designated image; and

performing a relevant service with the user service resource.

According to the foregoing aspect and any possible embodiment, an embodiment is further provided, that is, the processor further performs establishing the mapping relationship between the designated image and the user service resource so as to obtain the user service resource corresponding to the designated image according to the designated image.

According to the foregoing aspect and any possible embodiment, an embodiment is further provided, that is, the user service resource includes a user payment service resource.

According to the foregoing aspect and any possible embodiment, an embodiment is further provided, that is, the processor specifically performs

An image recognition processing on the designated image so as to obtain a recognition result and then obtains the user service resource according to the recognition result.

According to the foregoing aspect and any possible embodiment, an embodiment is further provided, that is, the designated image includes at least one or more of the following images:

a barcode image;

an object image; and

a picture image.

According to a third aspect of the present disclosure, there is provided with a non-transitory computer-readable storage medium, which stores computer executable instructions. The computer executable instructions can be set for:

acquiring a designated image collected by a vehicle-mounted terminal device;

obtaining a user service resource according to the designated image; and

performing a relevant service with the user service resource.

According to the foregoing aspect and any possible embodiment, there is further provided with an embodiment which, before obtaining a user service resource according to the designated image, further includes: establishing the mapping relationship between the designated image and the user service resource so as to obtain the user service resource corresponding to the designated image according to the designated image.

According to the foregoing aspect and any possible embodiment, an embodiment is further provided. The user service resource includes a user payment service resource.

According to the foregoing aspect and any possible embodiment, there is provided with an embodiment which, obtaining a user service resource according to the designated image, includes:

an image recognition processing on the designated image so as to obtain a recognition result, and

obtaining the user service resource according to the recognition result.

According to the foregoing aspect and any possible embodiment, an embodiment is further provided, that is, the designated image includes at least one or more of the following images:

a barcode image,

an object image, and

a picture image.

According to the technical solution, it can be seen that in embodiments of the present disclosure, a designated image collected by a vehicle-mounted terminal device is acquired, and further, a user service resource is obtained according to the designated image, so that the user service resource can be used to perform a relevant service such as a payment service. A user does not need to provide a physical card or an electronic card corresponding to a bank account or a corporation account, but only needs to activate an image acquisition function of the vehicle-mounted terminal to collect designated images. The operation is simple, and the accuracy is high, thus efficiency and reliability of resource exchange are improved.

In addition, in the technical solution provided by the present disclosure, since no requirement of a user to additionally carry a physical card or a terminal device that displays an electronic card enables the user not to provide a physical card or an electronic card corresponding to a bank account or a corporation account, user experience can be greatly improved.

The foregoing is merely a summary of the technical solution of the present disclosure. To know the technical means of the present disclosure more clearly so as to enable the technical means to be implemented according to content of the specification, and to make the foregoing and other objectives, features, and advantages of the present disclosure more obvious and easier to understand, specific embodiments of the present disclosure are particularly provided below.

### BRIEF DESCRIPTION OF THE DRAWINGS

Various other advantages and benefits will become apparent to a person skilled in the art upon reading the detailed description of the following preferable embodiments. The accompanying drawings are only used to show objectives of preferable embodiments, and shall not be considered as a limitation to the present disclosure. And elements having the same reference numeral designations represent like elements throughout. In the accompanying drawings:

FIG. 1 is a flow diagram of a resource processing method provided in an example of the present disclosure;

FIG. 2 is a structural diagram of a resource processing device provided in another example of the present disclosure;

FIG. 3 schematically shows a block diagram of a computing device for performing the resource processing method in accordance with an example of the present disclosure; and

FIG. 4 schematically shows a storage unit for holding or carrying program codes for implementing the resource processing method in accordance with an example of the present disclosure.

### DETAILED DESCRIPTION

Exemplary examples of the disclosure will be described below in more detail with reference to the drawings. Although the drawings show the exemplary examples of the present disclosure, it should be understood that the present disclosure can be implemented in various forms, and should not be limited to the examples described herein. Rather, these examples are provided so that the present disclosure will be understand more thoroughly, and will fully convey the scope of the disclosure to those skilled in the art.

It should be noted that the vehicle-mounted terminal device related in the examples of the present disclosure, also referred to as a vehicle computer, means a vehicle-mounted information entertainment product installed inside a car, with the function to enable information communication between people and the car and between the car and the outside (e.g., between the car and another car). The operating system of the vehicle-mounted terminal device can be, but are not limited to a Linux-based operating system, a WinCE-based operating system, a QNX operating system or an Android operating system. In this example, the operating system is not particularly restricted.

In addition, the term “and/or” in this document is merely a description of the associated relationship between associated objects, indicating that three relationships can exist, for example, A and/or B, which can be expressed as follows: A exist alone; both A and B exist; and B exists alone. In addition, the symbol “/” in this document generally represents that there is an alternative relationship between the former object and the latter one.

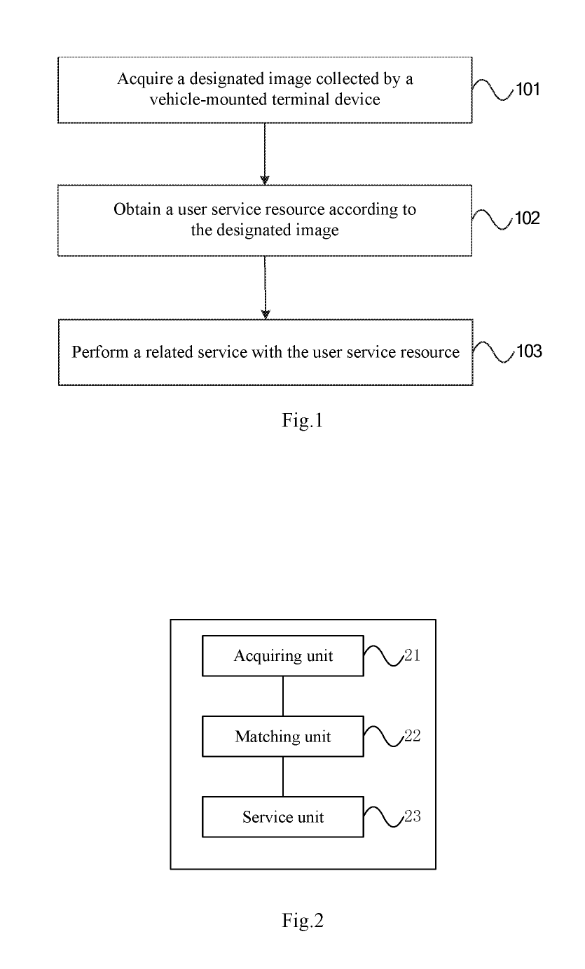

FIG. 1 is a flow diagram of a resource processing method provided in an example of the present disclosure, as shown in FIG. 1.

At step 101, acquire the designated image collected by a vehicle-mounted terminal device.

The image herein is a file formed by storing image data (i.e., pixels of the image) in a certain manner by adopting a certain image format, also called an image file.

Wherein, the image format of the image, i.e., the image format used to store the image, can include but is not limited to a Bitmap (BMP) format, a portable network graphics (PNG) format, a joint photographic experts group (JPEG) format, and an exchangeable image file format (EXIF), and are not particularly restricted in this example.

At step 102, obtain a user service resource based on the designated image.

At step 103, perform a related service with the user service resource.

It should be noted that the entity for performing the steps 101-103 can be an application located in the vehicle-mounted terminal device, or can also be a functional unit, such as a plug-in or a software development kit (SDK), disposed in an application located in the vehicle-mounted terminal device, and is not particularly restricted in this example.

As one will appreciate that the application can be a local native App installed on the vehicle-mounted terminal device, or be a web App of the browser on the vehicle-mounted terminal device, and is not particularly restricted in this example.

Thus, a designated image collected by a vehicle-mounted terminal device is acquired, and further, a user service resource is obtained according to the designated image, so that the user service resource can be used to perform a relevant service such as a payment service. A user does not need to provide a physical card or an electronic card corresponding to a bank account or a corporation account, but only needs to activate an image acquisition function of the vehicle-mounted terminal to collect designated images. The operation is simple, and the accuracy is high, thus efficiency and reliability of resource exchange are improved.

Alternatively, according to a possible embodiment of the present example, the vehicle-mounted terminal device can particularly collect the designated image with an image collecting device.

Wherein, the image collecting device can be an image sensor. For example, the image sensor can be a charge coupled device (CCD) sensor, or can also be a complementary metal-oxide semiconductor (CMOS) sensor, and is not particularly restricted in this example.

Specifically, the designated images can be a barcode image, such as a one-dimensional barcode or a two-dimensional barcode, or the image may also, for example, be a pattern on a user's body, the decorations in the car, or picture images, for example, the user-supplied pictures, which in this example is not particularly restricted.

Optionally, in a possible embodiment of this example, before the step 102, the method can also further include establishing the mapping relationship between the designated image and the user service resource, so as to obtain the user service resource corresponding to the designated image according to the designated image.

After establishing the mapping relationship between the designated image and the user service resource, the mapping relationship can be further stored. Specifically, the mapping relationship can be stored in a storage device of the vehicle-mounted terminal device.

In the course of a specific implementation, the storage device of the vehicle-mounted terminal device can be a slow storage device, particularly a non-operation memory (i.e., a physical memory) of the vehicle-mounted terminal device, for example, a read-only memory (ROM) and memory cards, etc., and is not particularly restricted in this example.

In the course of another specific implementation, the storage device of the vehicle-mounted terminal device can also be a fast storage device, particularly a running memory (i.e., a system memory) of the vehicle-mounted terminal device, for example, a random access memory (RAM), and is not particularly restricted in this example.

Optionally, in one possible embodiment of this example, the obtained user service resource can include but is not limited to a user payment service resource, and is not particularly restricted in this example.

Specifically, the user payment service resource can be a user payment account, or a user payment account and a user password, and is not particularly restricted in this example.

Optionally, in one possible embodiment of this example, at step 102, an existing image recognition technology can be specifically used to perform image recognition processing on the designated image, so as to obtain a recognition result. Then, a user service resource can be obtained according to the recognition result. Wherein, relevant contents in the prior art can be referred to for detailed description of the image recognition technology, which is not further discussed herein.

Optionally, in one possible embodiment of this example, at step 103, after acquiring the user service resource, the user account can be signed-in with the user service resource. A relevant service, for example, a payment service, is performed based on the user account.

In this example, a designated image collected by a vehicle-mounted terminal device is acquired, and further, a user service resource is obtained according to the designated image, so that the user service resource can be used to perform a relevant service such as a payment service. A user does not need to provide a physical card or an electronic card corresponding to a bank account or a corporation account, but only needs to activate an image acquisition function of the vehicle-mounted terminal to collect designated images. The operation is simple, and the accuracy is high, thus efficiency and reliability of resource exchange are improved.

In addition, in the technical solution provided by the present disclosure, since no requirement of a user to additionally carry a physical card or a terminal device that displays an electronic card enables the user not to provide a physical card or an electronic card corresponding to a bank account or a corporation account, user experience can be greatly improved.

It should be noted that the foregoing examples of the method have been described as a series of combinations of actions for brevity. However, a person skilled in the art should know that the present disclosure is not limited to the sequence of the described actions. As in accordance with the present disclosure, some steps can be performed in other sequences or synchronously. And secondly, a person skilled in the art should also know that actions and modules involved therein are not necessary for the present disclosure, as the examples described in the specification are all preferable examples.

In the examples, particular emphasis is laid respectively in their description; relevant descriptions of other examples can be referred to for a part of a certain example which is not described in detail.

FIG. 2 is a structural diagram of a resource processing device in accordance with another example of the present disclosure, as shown in FIG. 2. The resource processing device of this example can include an acquiring unit 21, a matching unit 22, and a service unit 23. Wherein, the acquiring unit 21 is configured to acquire designated image collected by a vehicle-mounted terminal device; the matching unit 22 is configured to obtain a user service resource according to the designated image; and the service unit 23 is configured to perform a relevant service with the user service resource.

Specifically, the designated image can be a bar code image, for example, a one-dimensional bar code or a two-dimensional bar code, or an object image, for example, a pattern on the body of the user, or a decoration in the car, or can also be a picture image, for example, a picture provided by the user, and is not particularly restricted in this example.

It should be noted that the resource processing device of this example can be an application located on a vehicle-mounted terminal device, or a functional unit, for example, a plug-in or a software development kit (SDK) provided in an application located on the vehicle-mounted terminal device, and is not particularly restricted in this example.

It can be understood that the application can be a native App installed on the vehicle-mounted terminal device, or a web App of a browser on the vehicle-mounted terminal device, and is not particularly restricted in this example.

Optionally, in one possible embodiment of this example, the matching unit 22 can be further configured to establish a mapping relationship between the designated image and the user service resource, so as to obtain the user service resource corresponding to the designated image according to the designated image.

Optionally, in one possible embodiment of this example, the user service resource obtained by the matching unit 22 can include but is not limited to a user payment service resource, and is not particularly restricted in this example.

Specifically, the user payment service resource can be a user payment account, or a user payment account and a user password, and is not particularly restricted in this example.

Optionally, in one possible embodiment of this example, the matching unit 22 can be specifically configured to perform image recognition processing on the designated image, so as to obtain a recognition result; and obtain the user service resource according to the recognition result.

It should be noted that the method in the example corresponding to FIG. 1 can be implemented by the resource processing device provided in this example. Relevant content in the example corresponding to FIG. 1 can be referred to for detailed description, which is not discussed further herein.

In the example, an acquiring unit is used for acquiring a designated image collected by a vehicle-mounted terminal device, further, a matching unit is used for obtaining a user service resource according to the designated images, so that a service unit can utilize the user service resource, and perform a related service such as payment service. Therefore, users do not need to provide a physical card or an electronic card corresponding to a bank account or a corporation account. Only the image acquisition function of the vehicle-mounted terminal needs to be activated to acquire the designated image. The operation is simple, and the accuracy is high, thus efficiency and reliability of resource exchange are improved.

In addition, according to the technical solution provided by the disclosure, as the user does not need provide a physical card or an electronic card corresponding to a bank account or a corporation account, the user do not need to additionally carry an physical card or a terminal device for displaying an electronic card, thus greatly improving user experience.

The algorithm and display provided here have no inherent relation with any specific computer, virtual system or other devices. Various general-purpose systems can be used together with the teaching based on this. According to the description above, the structure required to construct this kind of system is obvious. Besides, the disclosure is not directed at any specific programming language. It should be understood that various programming language can be used for achieving the content of the disclosure described here, and above description of specific language is for disclosing the optimum embodiment of the disclosure.

The description provided here explains plenty of details. However, it can be understood that the embodiments of the disclosure can be implemented without these specific details. The known methods, structure and technology are not sown in detail in some embodiments, so as not to obscure the understanding of the description.

Similarly, it should be understood that in order to simplify the disclosure and help to understand one or more of the various aspects of the disclosure, the various features of the disclosure are sometimes grouped into a single embodiment, drawings, or description thereof in the above description of the exemplary embodiments of the disclosure. However, the method disclosed should not be explained as reflecting the following intention: that is, the disclosure sought for protection claims more features than the features clearly recorded in every claim. To be more precise, as is reflected in the following claims, the aspects of the disclosure are less than all the features of a single embodiment disclosed before. Therefore, the claims complying with a specific embodiment are explicitly incorporated into the specific embodiment thereby, wherein every claim itself as an independent embodiment of the disclosure.

Those skilled in the art can understand that adaptive changes can be made to the modules of the devices in the embodiment and the modules can be installed in one or more devices different from the embodiment. The modules or units or elements in the embodiment can be combined into one module or unit or element, and furthermore, they can be separated into more sub-modules or sub-units or sub-elements. Except such features and/or processes or that at least some in the unit are mutually exclusive, any combinations can be adopted to combine all the features disclosed by the description (including the attached claims, abstract and figures) and any method or all process of the device or unit disclosed as such. Unless there is otherwise explicit statement, every feature disclosed by the description (including the attached claims, abstract and figures) can be replaced by substitute feature providing the same, equivalent or similar purpose.

In addition, a personal skilled in the art can understand that although some embodiments described here include some features instead of other features included in other embodiments, the combination of features of different embodiments means falling into the scope of the disclosure and forming different embodiments. For example, in the following claims, any one of the embodiments sought for protection can be used in various combination modes.

The various components embodiments of the disclosure can be realized by hardware, or realized by software modules running on one or more processors, or realized by combination thereof. A person skilled in the art should understand that microprocessor or digital signal processor (DSP) can be used for realizing some or all functions of some or all components according to the embodiments in the disclosure in practice. The disclosure can also realize one part of or all devices or programs (for example, computer programs and computer program products) used for carrying out the method described here. Such programs for realizing the disclosure can be stored in computer readable medium, or can possess one or more forms of signal. Such signals can be downloaded from the Internet website or be provided at signal carriers, or be provided in any other forms.

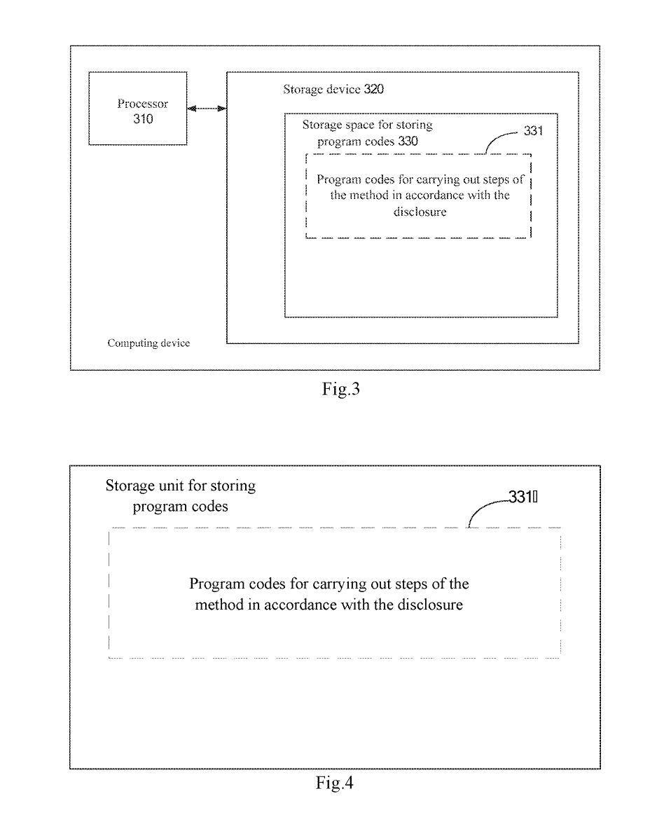

For example, FIG. 3 shows a computing device for achieving the parking method according to the disclosure. The computing device traditionally includes a processor 310 and a computer program product or a computer readable medium embodying as a storage device 320. The storage device 320 can be electronic storage such as flash memory, EEPROM (Electrically Erasable Programmable Read-Only Memory), EPROM, hard disk or ROM, and the like. The storage device 320 possesses storage space 330 for storing program codes 331 for carrying out any steps of aforesaid method. For example, storage space 330 for storing program codes can include various program codes 331 used for realizing any steps of aforesaid method. These program codes can be read out from one or more computer program products or write in one or more computer program products. The computer program products include program code carriers such as hard disk, Compact Disc (CD), memory card or floppy disk and the like. These computer program products usually are portable or fixed storage cell as shown in FIG. 4. The storage cell can possess memory paragraph, storage space like the storage device 320 in the computing device in FIG. 3. The program code can be compressed in, for example, a proper form. Generally, storage cell includes computer readable code 331′ for performing method steps of the embodiments, i.e. the code can be read by processors such as 310 and the like. When the codes run on a computer device, the computer device will carry out various steps of the method described above.

In addition, there is provided with a non-transitory computer-readable storage medium, which stores computer executable instructions. The computer executable instructions can perform source processing methods mentioned by any of above embodiments, which specifically includes:

acquiring a designated image collected by a vehicle-mounted terminal device;

obtaining a user service resource according to the designated image; and

performing a relevant service with the user service resource.

before obtaining a user service resource according to the designated image, further includes:

establishing the mapping relationship between the designated image and the user service resource so as to obtain the user service resource corresponding to the designated image according to the designated image.

The user service resource includes a user payment service resource.

The step of obtaining a user service resource according to the designated image, includes an image recognition processing on the designated image so as to obtain a recognition result, and obtaining the user service resource according to the recognition result.

The designated image includes at least one or more of the following images: a barcode image, an object image, and a picture image.

It should be noticed that the embodiments are intended to illustrate the disclosure and not limit this disclosure, and a person skilled in the art can design substitute embodiments without departing from the scope of the appended claims. In the claims, any reference marks between brackets should not be constructed as limit for the claims. The word “include” does not exclude elements or steps that are not listed in the claims. The word “a” or “one” before the elements does not exclude that more such elements exist. The disclosure can be realized by means of hardware including several different elements and by means of properly programmed computer. In the unit claims several devices are listed, several of the devices can be embodied by a same hardware item. The use of words first, second and third does not mean any sequence. These words can be explained as name.

1-10. (canceled)

11. A resource processing method, which includes:
acquiring a designated image collected by a vehicle-mounted terminal device;
obtaining a user service resource according to the designated image; and
performing a relevant service with the user service resource.

12. The method of claim 11, which further includes the following before the step of obtaining a user service resource according to the designated images:
establishing the mapping relationship between the designated images and the user service resource so as to obtain the user service resource corresponding to the designated images according to the designated images.

13. The method of claim 11, wherein, the user service resource comprises a user payment service resource.

14. The method of claim 11, wherein, the step of obtaining a user service resource according to the designated images includes:
carrying out image recognition processing on the designated images so as to obtain a recognition result; and
obtaining a user service resource according to the recognition result.

15. The method of any one of claims 11, wherein, the designated image includes one or more of the following images:
a barcode image;
an object image; and
a picture image.

16. A resource processing device, which includes:
one or more of processor, and a storage.
wherein, one or more program is stored in the storage. One or more program is executed by one or more processor, and enables one or more processor to perform:
acquiring a designated image collected by a vehicle-mounted terminal device;
obtaining a user service resource according to the designated image; and
performing a relevant service with the user service resource.

17. The device of claim 16, wherein, the processor further performs:
establishing the mapping relationship between the designated image and the user service resource so as to obtain the user service resource corresponding to the designated image according to the designated image.

18. The device of claim 16, wherein, the user service resource includes a user payment service resource.

19. The device of claim 16, wherein, the processor performs image recognition processing on the designated image so as to obtain a recognition result; and obtains the user service resource according to the recognition result.

20. The device of claims 16, wherein, the designated image includes one or more of the following images:
a barcode image;
an object image; and
a picture image.

21. A non-transitory computer-readable storage medium, which stores computer executable instructions. The computer executable instructions can be set for:
acquiring a designated image collected by a vehicle-mounted terminal device;
obtaining a user service resource according to the designated image; and
performing a relevant service with the user service resource.

22. The non-transitory computer-readable storage medium according to claim 21, before obtaining a user service resource according to the designated image, further includes:
establishing the mapping relationship between the designated image and the user service resource so as to obtain the user service resource corresponding to the designated image according to the designated image.

23. The non-transitory computer-readable storage medium according to claim 21, wherein, the user service resource includes a user payment service resource.

24. The non-transitory computer-readable storage medium according to claim 21, wherein, the step of obtaining a user service resource according to the designated image includes an image recognition processing on the designated image so as to obtain a recognition result, and obtaining the user service resource according to the recognition result.

25. The non-transitory computer-readable storage medium according to claim 21, the designated image includes at least one or more of the following images:
a barcode image,
an object image, and
a picture image.
